(19) United States
(12) Patent Application Publication
(10) Pub. No.: US 2023/0192408 A1
(43) Pub. Date: Jun. 22, 2023

(54) SYSTEMS AND METHODS OF SORTING AND CONVEYING PRODUCE

(71) Applicant: Roller Conveyor, LLC, Paso Robles, CA (US)

(72) Inventors: James Patrick McKnight, Paso Robles, CA (US); Thomas Dwain Spurger, Exeter, CA (US)

(21) Appl. No.: 17/960,748

(22) Filed: Oct. 5, 2022

Related U.S. Application Data
(60) Provisional application No. 63/252,591, filed on Oct. 5, 2021.

(51) Int. Cl. B65G 17/36; B65G 47/38; B65G 47/24; B65G 23/20

(52) U.S. Cl. CPC B65G 17/36; B65G 47/38; B65G 47/24; B65G 23/20; B65G 2201/0211

(57) ABSTRACT

A producing conveying system may include a conveying assembly having a continuous drive chain for driving the conveyance of produce along a plurality of fingers engaged with the drive chain. A conveying assembly may include a pair of augers, with a first auger extending across a first set of fingers and with a second auger extending across a second set of fingers. Each of the augers may rotate produce as the produce is conveyed, with the rotational axis being parallel to the direction of conveyance. A conveying assembly can also include a finger retention track for retaining a retention tab of a finger therein during produce conveyance. At an unloading portion of the conveying assembly, an ejection cam disposed within openings in the finger retention track may be actuated to allow the release of the retention tab and subsequent ejection of produce.

### CROSS-REFERENCE TO RELATED APPLICATIONS

The present application claims priority to, and the benefit of, U.S. Provisional Patent Application No. 63/252,591, filed Oct. 5, 2021, which is hereby incorporated by reference in its entirety.

### FIELD OF THE INVENTION

The present invention concerns systems and methods for conveying and sorting produce. More particularly, some embodiments of the present invention concern systems and methods for conveying produce under an inspection process and selectively ejecting the produce based on produce grade.

### BACKGROUND OF THE INVENTION

Conventional conveying and sorting systems typically comprise a conveyor having a continuous chain-like construction which moves in a line from a loading and singulating portion, to an inspection portion, and then to a sorting area where produce is selectively sorted based on inspection (which could include inspecting for color, shape, and size, among other characteristics). Conventionally, the rotation of the produce in the direction of conveyor travel (i.e., the produce rolls forward in the direction of conveyor travel), rather than perpendicular to the direction of travel. The produce is ejected by being selectively dropped by the system on to the appropriate exit station in the sorting area of the conveyor

For example, many types of conventional conveyance systems utilize a plurality of rollers arranged such that their rotational axes are perpendicular to the direction of conveyance, meaning the direction of rotation of the conveying surface is parallel to the direction of conveyance. Consequently, produce being conveyed on such systems is also rotated in the direction of conveyance. Furthermore, conventional conveying systems require relatively large amounts of space and are comprised of assemblies of many parts, which requires more maintenance to keep these systems functioning. For example, systems which utilize a plurality of rollers require a plurality of drive mechanisms to accommodate the rollers. Consequently, in addition to requiring more space, this requires these parts to be inspected and repaired or replaced more frequently.

Therefore, the need exists for a conveying system which can convey and rotate produce while utilizing less space and less materials. More particularly, the need exists for a conveying system which can rotate produce in a direction perpendicular to the direction of conveyance, without any hinderance of the conveying motion. Furthermore, the need exists for a conveying system which utilizes a single drive mechanism to rotate produce during conveyance.

### BRIEF SUMMARY OF THE INVENTION

The present invention generally concerns systems for conveying produce as well as methods for achieving the same. In some embodiments, a conveying system may include a conveying assembly which may have a continuous drive chain for driving the conveyance of produce. Produce may enter a loading portion, then a singulating portion, then an inspection portion, and then an unloading portion. Within the singulating portion, produce may be separated prior to reaching the inspection portion. After the inspection portion, produce may be conveyed until it reaches the unloading portion where it is ejected. In some embodiments, a conveying assembly may comprise a plurality of conveyance lanes.

According to some embodiments, the drive chain may be driven in a continuous motion by means of one or more sprockets. Within the conveying assembly, the direction of conveyance is generally from the loading portion to the unloading portion, with the direction of conveyance being opposite on a returning portion of the drive chain. The drive chain may be supported by, and slidably engaged with, a support track.

In some embodiments, produce may be conveyed on one or more fingers which may extend from a finger mounting bracket engaged with the drive chain. As a finger travels into the unloading portion, the finger may drop to allow the produce to be ejected onto a chute. As the finger reaches the end of the unloading portion, it may be returned to its original position, ready to receive produce. The finger may be guided onto a return track and eventually returned back to the loading portion for receiving produce.

According to some embodiments, a conveying assembly may include one or more augers which may extend in the direction of conveyance along one or more fingers. An auger may be driven (i.e., rotated) by an auger drive which may include a motor, a drive shaft, one or more pulleys, and one or more belts. An auger may be used to separate produce within the singulating portion. An auger may also aid with the inspection of produce within the inspection portion.

In accordance with some embodiments of the present invention, a finger of a conveying assembly may generally comprise an elongate body which may extend from the drive chain of the conveying assembly. A finger may comprise a receiving surface which may have a convex shape configured to retain produce therein during conveyance of the same. In accordance with some embodiments, a finger may have a cavity near an apex of the receiving surface within which a portion of an auger may be disposed. A cavity may induce contact between produce and an auger positioned within the cavity.

In some embodiments, a finger may be indirectly engaged to the drive chain by a finger mounting bracket which may be engaged to the drive chain. A finger mounting bracket may comprise a slot configured to receive and retain a portion of the drive chain. In some embodiments, a finger mounting bracket may comprise a pair of notches which may be configured to receive a portion of the drive chain. In some embodiments, a finger mounting bracket may be engaged with a drive chain by a pin which may be received through portions of the drive chain and finger mounting bracket. According to some embodiments of the present invention, a finger may be hingedly engaged with a finger mounting bracket. In some embodiments, a finger may be engaged to a finger mounting bracket by inserting a pivot pin through an opening in the finger mounting bracket and engaging the finger with the pivot pin.

In accordance with some embodiments, and as previously described, a conveying assembly may comprise one or more augers for rotating produce. An auger may be generally elongated, extending across a plurality of fingers. In some embodiments, an auger may have a longitudinal axis which may be about parallel to a drive chain. Additionally, the longitudinal axis of an auger may be about parallel to the direction of conveyance.

According to some embodiments, an auger may generally comprise a shank and/or fighting. In some embodiments, the fighting may be wound around the shank or may be integrally formed therewith. A fighting may formed as a ridge, protrusion, plate, or any other shape. A fighting may be formed in helical pattern. In some embodiments, an auger may comprise a shank without fighting or an auger may comprise fighting without a shank.

According to some embodiments of the present invention, an auger may be configured to rotate such that it may impart rotation on produce which may be in contact with the auger. In preferred embodiments, an auger may rotate about a longitudinal axis which may be oriented about parallel to a drive chain. In some implementations, a pair of adjacent augers may rotate in opposite directions. According to some implementations, a top surface of a pair of adjacent augers may rotate towards a drive chain. During rotation of a pair of augers, a top surface of produce may rotate away from a drive chain.

During operation of a conveying assembly, as a drive chain moves in the direction of conveyance, one or more fingers may be driven in a direction parallel to the direction of conveyance so as to convey produce toward the unloading portion of the conveying assembly. An auger may also assist with the conveyance of produce on one or more fingers by forcing the produce in the direction of conveyance. Furthermore, an auger may also assist with the retention of produce on one or more corresponding fingers.

In accordance with some embodiments of the present invention, during conveyance of produce by a conveying assembly, an auger may simultaneously rotate about its longitudinal axis to induce rotation on the produce. In some implementations, an auger may rotate in a counterclockwise direction while produce rotates in a clockwise direction, causing a top surface of the produce to rotate generally toward a drive chain. The concurrent motions of a drive chain and an auger may cause produce to be conveyed in a direction while simultaneously rotating about an axis which may be about parallel to the direction of conveyance.

According to some embodiments of the present invention, as a finger travels in the direction of conveyance, its orientation may be retained by a retention track engaged with the finger. In some embodiments, a finger may comprise a retention tab which may be housed in a finger retention track. As the finger moves toward the unloading portion of a conveying assembly, the retention tab may abut an inside surface of the finger retention track, thus preventing the finger from pivoting downward and ejecting produce. When the finger arrives at the unloading portion, openings in the retention track may allow the finger to change orientations. In some embodiments, an actuator may control a cam disposed adjacent to an opening of the retention track which may the finger to be released and eject produce. According to some embodiments, a free end of the ejection cam may be actuated such that it pivots inwardly toward the retention track and such that the retention tab of the finger, which is moving in the direction of conveyance, contacts the ejection cam, forcing the finger to pivot downward and eject produce.

In some embodiments of the present invention, a conveying assembly may comprise a plurality of gears disposed underneath a plurality of fingers and which may be aligned with an apex of the fingers. A gear may generally rotate in a direction of conveyance and a tooth pitch and width of a gear may correspond to a space between two adjacent fingers. In some embodiments, a plurality of gears may be arranged in a line and rotated slightly from a centerline. During operation of a conveying assembly, as the fingers move in the direction of conveyance, they may catch the teeth of a gears and drive the rotation thereof. As a gear rotates, the tips of the gear teeth may contact a peripheral surface of produce, causing it to rotate. Furthermore, and according to some embodiments, a gear may be configured to contact a finger, causing the finger to be moved in an upward direction which may assist with the rotation of produce.

According to some embodiments of the present invention, a system for the conveyance of produce may comprise: a drive chain; a finger retention track above the drive chain; a finger mounting bracket which may be engaged with the drive chain; a finger which may comprise a surface for supporting the produce and a retention tab, wherein the finger may be hingedly engaged with the finger mounting bracket, and wherein the finger surface may (i) distally extend from the finger mounting bracket, (ii) comprise a generally upwardly convex shape, and (iii) comprise a cavity near the apex thereof; and an elongate auger for rotating the produce and which may have a longitudinal axis that may be parallel to the drive chain, wherein the auger may (i) be at least partially positioned in the cavity of the finger surface, (ii) comprise a top surface which may be rotatable towards the drive chain, and (iii) comprise a shaft and flighting. In some embodiments, the system may further comprise a chain support below the drive chain. In some embodiments, the drive chain may slidably engage the chain support. In some embodiments, the finger may have a first orientation and a second orientation. In some embodiments, when the finger has the first orientation, the retention tab of the finger may be within the finger retention track. In some embodiments, when the finger has the second orientation, the retention tab of the finger may not be within the finger retention track. In some embodiments, the auger flighting may be around a portion of the auger shaft. In some embodiments, the auger flighting may be integrally formed with the auger shaft. In some embodiments, the auger fighting may be engaged with the auger shaft. In some embodiments, the auger fighting may have a helical shape. In some embodiments, the system for the conveyance of produce may further comprise an auger drive for rotating the auger and the auger drive may comprise a shaft. In some embodiments, the auger drive may comprise a pulley engaged with the auger shaft, a pulley engaged with the auger drive shaft, and a belt engaged to each of the pulley of the auger shaft and the pulley of the auger drive shaft. In some embodiments, the system for the conveyance of produce may further comprise a motor engaged to the auger drive shaft.

According to some embodiments of the present invention, a system for inspecting produce may have a loading portion, an inspection portion, and an unloading portion and may comprise a plurality of lanes, where each lane may comprise: a) a drive chain between a drive chain support and a finger retention track; b) a plurality of fingers on each side of the drive chain, wherein each of the fingers may be hingedly engaged with a corresponding one of a plurality of finger mounting brackets, wherein each of the finger mounting brackets may be engaged with the drive chain, and wherein each of the fingers (i) may comprise a surface for supporting the produce and may have a cavity therein, (ii) may comprise a retention tab, and (iii) may have a first orientation and a second orientation; c) and at least two augers, wherein a first auger may be on a first side of the drive chain and wherein a second auger may be on a second side of the drive chain, wherein each of the augers (i) may have a longitudinal axis that may be parallel to the drive chain, (ii) may be at least partially positioned in the cavities of the surfaces of at least two of the fingers, and (iii) may comprise a top surface which may rotate toward the drive chain. In some embodiments, in the loading portion, each of the fingers may have the first orientation and the retention tab of each of the fingers may be within the finger retention track. In some embodiments, in the inspection portion, each of the fingers may have the first orientation and the retention tab of each of the fingers may be within the finger retention track. In some embodiments, in the inspection portion, the auger may comprise fighting for rotating the produce for inspection. In some embodiments, in the unloading portion, each finger retention track may comprise a plurality of openings therein. In some embodiments, in the unloading portion, the retention tab of each of the fingers may be ejected from one of the finger retention track openings. In some embodiments, each lane may further comprise a plurality of ejection actuators which may have an ejection cam engaged thereto, and wherein the ejection cam may have a first orientation and a second orientation. In some embodiments, each of the ejection cams may be positioned near one of the finger retention track openings. In some embodiments, when the ejection cam has the first orientation, the cam may be outside of the finger retention track opening, and wherein when the ejection cam has the second orientation, a portion of the ejection cam may be through the finger retention track opening and in the finger retention track. In some embodiments, in the loading portion, (i) each of the fingers may have the first orientation and (ii) the retention tab of each of the fingers may be within the finger retention track; in the inspection portion, (i) each of the fingers may have the first orientation, (ii) the retention tab of each of the fingers may be within the finger retention track, and (iii) the auger may comprise fighting for rotating the produce for inspection; and in the unloading portion, (i) each finger retention track may comprise a plurality of openings therein, (ii) each lane may further comprise a plurality of ejection actuators which may have an ejection cam engaged thereto, wherein each of the ejection cams may be positioned near one of the finger retention track openings, (iii) the ejection cam may have a first orientation when the ejection cam may be outside of the finger retention track opening, and (iv) the ejection cam may have a second orientation when a portion of the ejection cam may be through the finger retention track opening and in the finger retention track.

According to some embodiments of the present invention, a method for conveying produce through a machine may comprise a drive chain and may have a loading, inspection, and unloading portion, wherein the drive chain may move from the loading portion to the inspection portion and from the inspection portion to the unloading portion, wherein the method may comprise the steps of: a) in the loading portion, (i) positioning a retention tab of each of a plurality of fingers within a finger retention track, wherein each of the plurality of fingers may be hingedly engaged with one of a plurality of finger mounting brackets, wherein each finger mounting bracket may be engaged with the drive chain, and (ii) placing the produce on a surface of at least one of the plurality of fingers; b) in the inspection portion, (i) positioning the produce to be engaged with an auger, wherein the auger may be at least partially positioned in a cavity of the finger surface and may have a longitudinal axis that may be parallel to the drive chain, and (ii) rotating the auger to cause the produce to rotate along an axis which may be parallel with the longitudinal axis of the auger; and c) in the unloading portion, (i) ejecting each retention tab through one of a plurality of openings in the finger retention track, and (ii) removing the produce from the surface of the finger.

### BRIEF DESCRIPTION OF THE DRAWINGS

FIG. 1 is a side view illustrating an exemplary conveying assembly for conveying produce in accordance with some embodiments of the present invention.

FIG. 2 is a rear view illustrating the conveying assembly of FIG. 1, as view along the section X-X.

FIG. 3 is a rear view illustrating the conveying assembly of FIG. 1, as view along the section Y-Y.

FIG. 4 is a rear view illustrating the conveying assembly of FIG. 1, as view along the section Z-Z.

FIG. 5 is a rear view illustrating a portion of an exemplary conveying assembly in accordance with some embodiments of the present invention.

FIG. 6 is a rear view illustrating an exemplary finger mounting bracket and drive chain of FIG. 5.

FIG. 7 is a rear view illustrating a portion of an exemplary conveying assembly in accordance with some embodiments of the present invention.

FIG. 8 is a rear view illustrating an exemplary finger mounting bracket, drive chain, and pin of FIG. 7.

FIG. 9 is a partially exploded top view illustrating a portion of the conveying assembly of FIG. 7.

FIG. 10 is a top view illustrating a portion of an exemplary conveying assembly in accordance with some embodiments of the present invention.

FIG. 11 is a side view illustrating an exemplary auger of FIG. 10.

FIG. 12 is a top view illustrating a portion of an exemplary conveying assembly in accordance with some embodiments of the present invention.

FIG. 13 is a side view illustrating an exemplary auger of FIG. 12.

FIG. 14 is a side view illustrating an exemplary auger in accordance with some embodiments of the present invention.

FIG. 15 is a side view illustrating an exemplary auger in accordance with some embodiments of the present invention.

FIG. 16 is a top view illustrating a portion of an exemplary conveying assembly in accordance with some embodiments of the present invention.

FIG. 17 is a rear view illustrating a portion of the conveying assembly of FIG. 16.

FIG. 18 is a rear view illustrating a portion of an exemplary conveying assembly in accordance with some embodiments of the present invention.

FIG. 19 is a side view illustrating an exemplary gear of FIG. 18.

FIG. 20 is a top view illustrating a portion of the conveying assembly of FIG. 18.

### DETAILED DESCRIPTION OF THE INVENTION

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention, including any length, angles, or other measurements provided. Rather the invention, as defined by the claims, may cover alternatives, modifications, and/or equivalents of the exemplary embodiments.

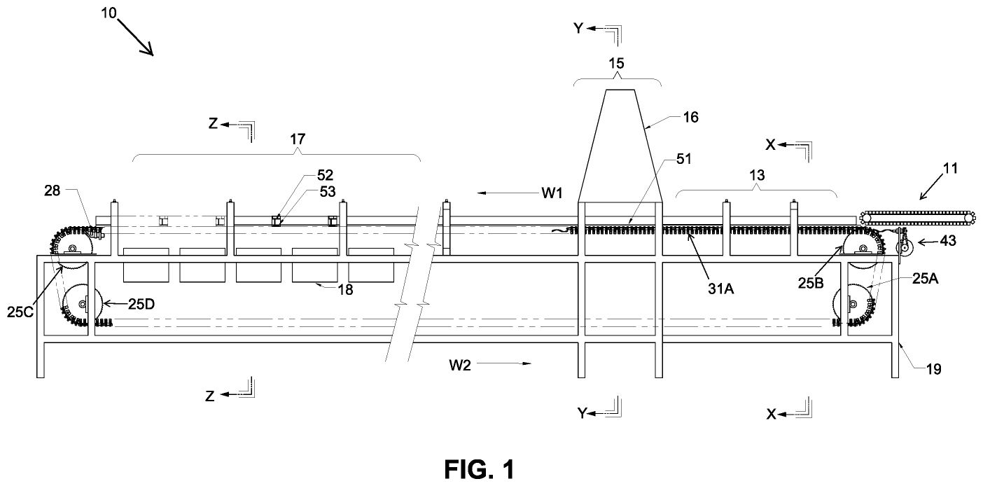

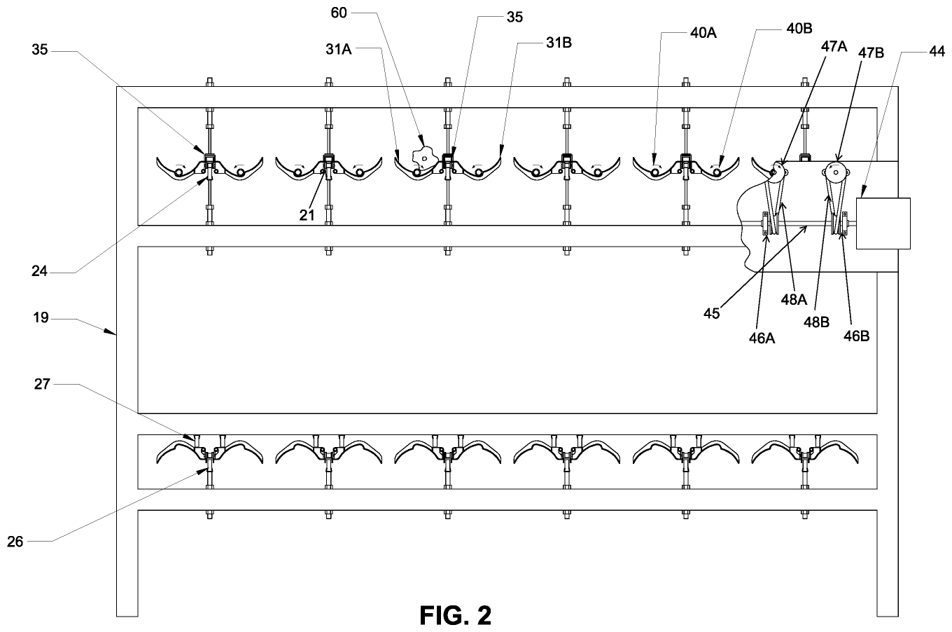

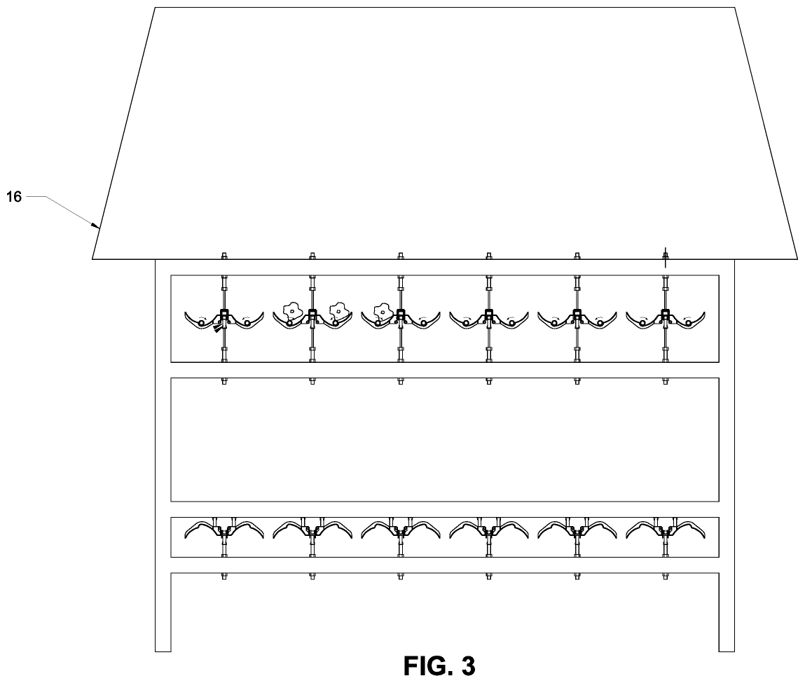

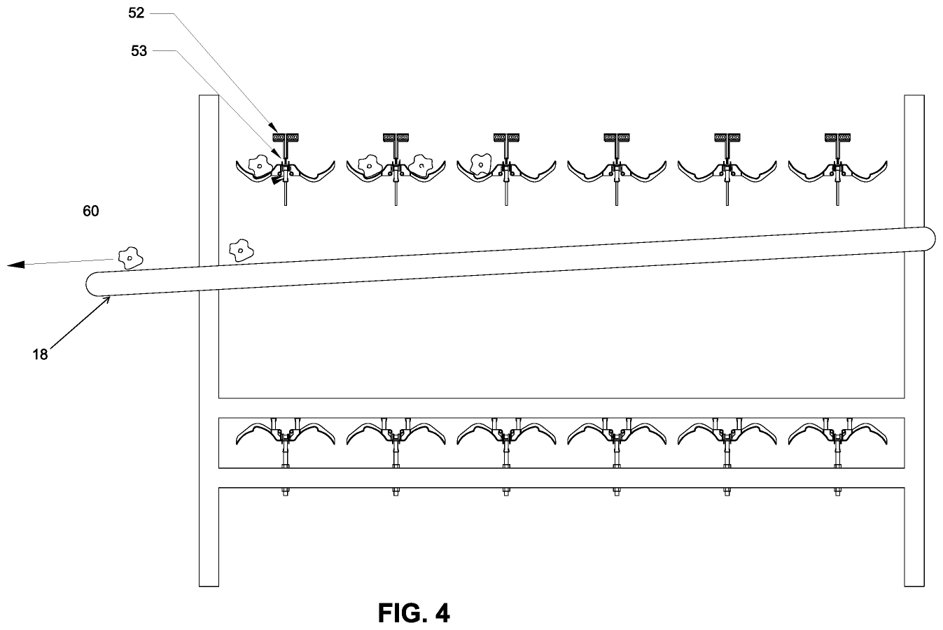

FIGS. 1-4 illustrate an exemplary system for conveying produce may comprise a conveying assembly 10 having a continuous drive chain 21 (see also, in connection with other embodiments, drive chain 421 of FIG. 10) for driving the conveyance of produce initially entering a loading portion 11 of conveying assembly 10. Produce entering conveying assembly 10 may pass through a singulating portion 13, then to an inspection portion 15, and then to an unloading portion 17. Within singulating portion 13, produce may be separated or ordered into one or more discrete lines prior to reaching inspection portion 15. After inspection portion 15, produce may continue to be conveyed until it reaches unloading portion 17 where it is dropped or otherwise moved from fingers (in accordance with embodiments of the present invention) onto an unloading chute 18, as more clearly illustrated in FIG. 4. It is to be appreciated that a conveying assembly may comprise a plurality of conveyance lanes which may operate in unison, or independently. For example, as illustrated in FIGS. 2-4, conveying assembly 10 may comprise a plurality conveyance lanes each may comprise, inter alia, a drive chain, fingers, and augers.

As further illustrated in FIG. 1, drive chain 21 may be driven in a continuous motion by means of drive chain sprockets 25A and 25B, disposed near a loading side of conveying assembly 10 (i.e., the side near which loading portion 11 is located), and drive chain sprockets 25C and 25D, disposed near an unloading side of conveying assembly (i.e., the side near which unloading portion 17 is located). As oriented in FIG. 1, the direction of conveyance is generally from the loading side to the unloading side, indicated by direction W1, with the direction of conveyance being opposite on a returning portion of the drive chain, generally indicated by direction W2. Along the conveying portion of conveying assembly 10, drive chain 21 may be supported by a chain support track 24 (see, e.g., FIG. 2). Along the returning portion, drive chain 21 may be supported by a return support track 26.

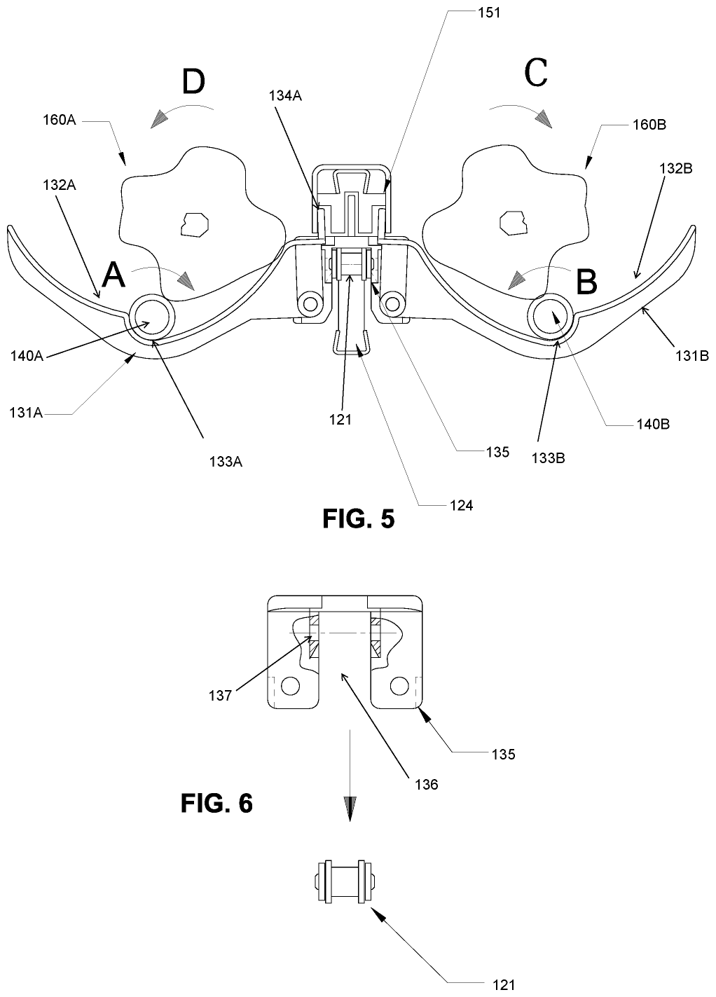

As further illustrated in FIGS. 1-4 (see also, e.g., FIG. 5) produce 60 may be conveyed on a plurality of fingers 31A and 31B which may extend from a finger mounting bracket 35 engaged with drive chain 21. As fingers 31A and 31B travel from loading portion 11 and eventually into unloading portion 17, fingers 31A and 31B may drop to allow the release of produce 60 onto one of a plurality of unloading chutes 18 (explained in further detail below). As fingers 31A and 31B reach the end of unloading portion 17, any of fingers 31A and 31B which are in a dropped position may be returned to their original position by a cam 28 disposed between the end of unloading portion 17 and drive chain sprocket 25C. Fingers 31A and 32B are then guided by drive chain sprockets 25C and 25D onto a return track 26 (see, e.g., FIG. 2), and supported by a stabilizing track 27, where fingers 31A and 32B are eventually returned back to loading portion 11 by drive chain sprockets 25A and 25B.

As illustrated, for example, in FIG. 2, conveying assembly 10 may include augers 40A and 40B (explained in further detail below) which may extend in the direction of conveyance along fingers 31A and 31B throughout a portion of the conveyance path, or in this example, throughout singulating portion 13 and inspection portion 15. Augers 40A and 40B may be driven (i.e., rotated) by an auger drive 43 (see FIG. 1) which may comprise a motor 44, a drive shaft 45, drive shaft pulleys 46A (partially illustrated) and 46B, auger pulleys 47A and 47B, and belts 48A and 48B. More particularly, and according to some embodiments, drive shaft 45 may be engaged to motor 44 and drive shaft pulleys 46A and 46B may be engaged with drive shaft 45 and oriented such that the axes of rotation of drive shaft pulleys 46A and 46B are parallel to an axis of rotation of drive shaft 45. Belts 48A and 48B may be engaged with drive shaft pulleys 46A and 46B, respectively, and auger pulleys 47A and 47B, respectively. As further illustrated in FIG. 2, belt 48A may be rotated about 90 degrees between drive shaft pulley 46A and auger pulley 47A. Likewise, belt 48B may be rotated about 90 degrees between drive shaft pulley 46B and auger pulley 47B, with belt 48B being rotated in an opposite direction to that of belt 48A to induce rotation of augers 40A and 40B in opposite directions. In some other embodiments, the augers may be driven by drive chain via one or more gears engaged with both the drive chain and the augers. Augers 40A and 40B may be used to separate produce 60 within singulating portion 13. In addition, augers 40A and 40B may aid with the inspection of produce 60 within inspection portion 15 by, for example, rotating produce 60 (explained in further detail below) as it is inspected by an inspection device 16.

In accordance with some embodiments of the present invention, a finger of a conveying assembly may generally comprise an elongate body which may extend from the drive chain of the conveying assembly. For example, and with reference to FIG. 5, fingers 131A and 131B may generally extend from, and may be oriented about perpendicular to, a finger mounting bracket 135 (which is engaged with a drive chain 121). A receiving surface 132A and 132B of fingers 131A and 131B, respectively, may generally have an upwardly convex shape (according to the orientation in FIG. 5) which may be configured to retain produce 160A and 160B, respectively, therein. In accordance with some embodiments, and as further illustrated in FIG. 5, for example, fingers 131A and 131B may each have a cavity 133A and 133B near an apex of receiving surface 132A and 132B, respectively, and within which a portion of auger 140A and 140B, respectively, may be positioned. A cavity may be configured to direct, or otherwise encourage, contact between the auger and produce positioned on the finger.

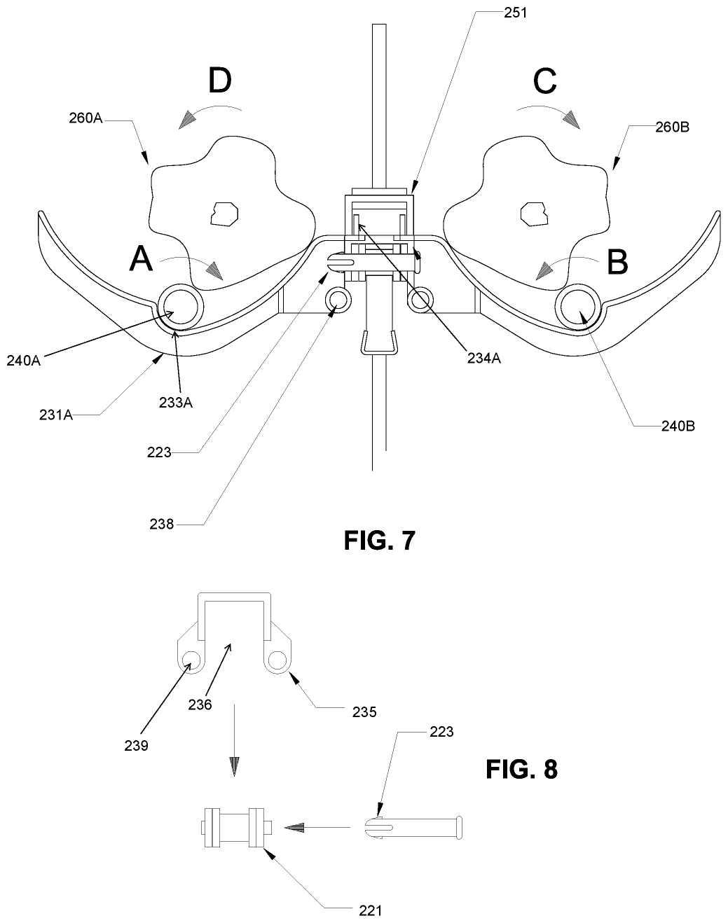

As further illustrated in FIG. 5, and also with reference to FIG. 6, fingers 131A and 131B may be indirectly engaged to drive chain 121 by means of finger mounting bracket 135 which may be engaged to drive chain 121. According to some embodiments, and as more clearly illustrated in FIG. 6, for example, finger mounting bracket 135 may comprise a slot 136 configured to receive and retain a portion of drive chain 121 therein. More particularly, and in accordance with some embodiments, finger mounting bracket 135 may comprise a pair of notches 137 adjacent to slot 136 which may have a shape configured to receive a portion of the outer surface of drive chain 121. According to some embodiments, a finger mounting bracket may be engaged with a drive chain by a pin which may be received through portions of the drive chain and finger mounting bracket. For example, as illustrated in FIGS. 7 and 8, a finger mounting bracket 235 may comprise a slot 236 configured to receive a portion of a drive chain 221 therein, and drive chain 221 may be retained within slot 236 by means of a pin 223 received through aligned openings (not illustrated) in drive chain 221 and finger mounting bracket 235.

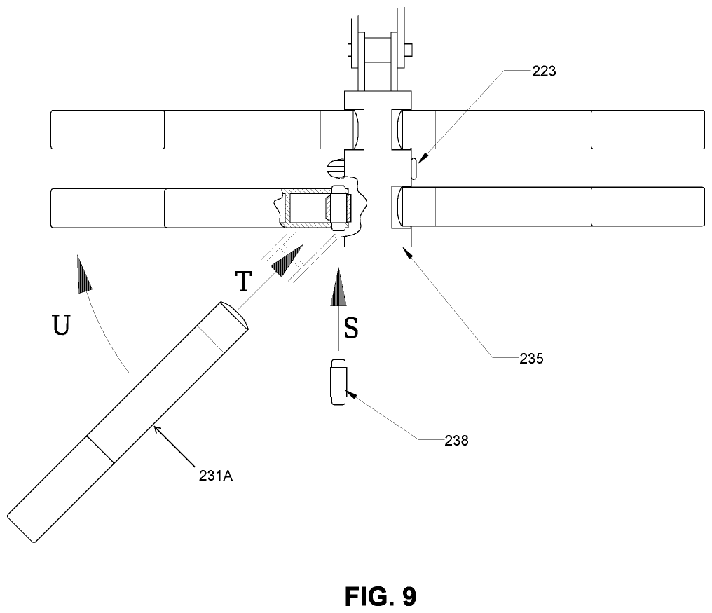

According to some embodiments of the present invention, a finger may be hingedly engaged with a finger mounting bracket. For example, and with further reference to FIGS. 7 and 8, and additionally FIG. 9, finger 231A may be hingedly engaged to finger mounting bracket 235 by a pivot pin 238 received through an opening 239 of finger mounting bracket 235 and abutting an ear formed in finger 231A (not illustrated). In accordance with some embodiments, for purposes of assembly, finger 231A may be engaged to finger mounting bracket 235 by inserting pivot pin 238 through opening 239 finger mounting bracket 235, designated by direction Sin FIG. 9, bringing finger 231A into a motion designated by direction T, with the ear of finger 231A hooking around pivot pin 238. Finger 231A is then swung in direction U until the ear of finger 231A cams over pivot pin 238 and “snaps” into place.

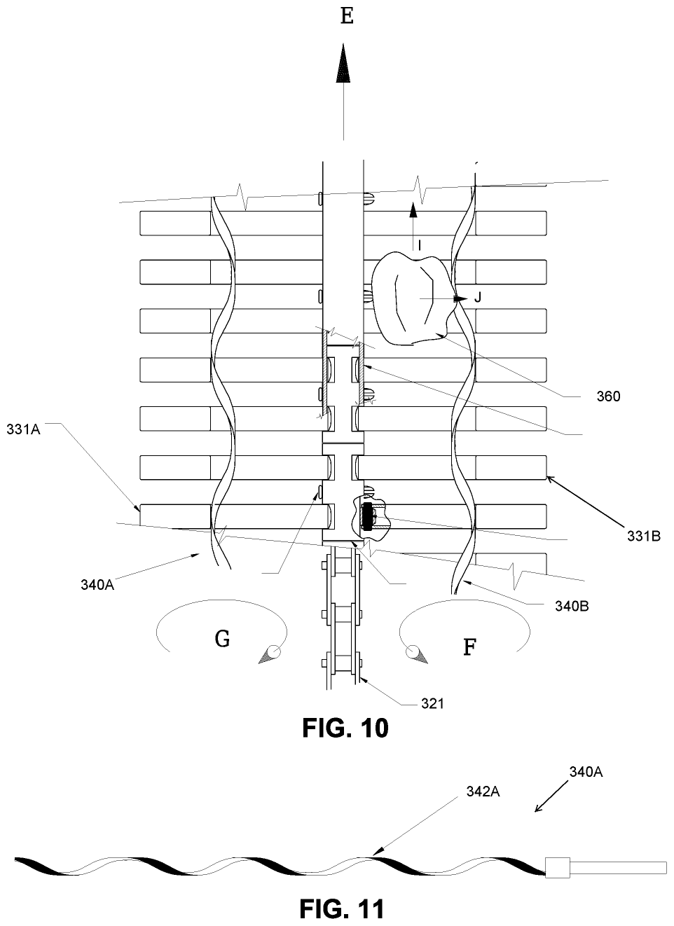

In accordance with some embodiments, and as briefly described above, a conveying assembly may also comprise one or more augers for rotating produce. For example, referring back to FIG. 5, portions of augers 140A and 140B may be disposed within cavity 133A and 133B, respectively (see also, e.g., augers 240A and 240B of FIG. 7). In some embodiments, an auger may be generally elongated, extending across a plurality of fingers. Furthermore, and according to some embodiments, an auger may have a longitudinal axis which may be about parallel to a drive chain. For example, and with reference to FIGS. 10 and 11 an auger 340A may extend along a plurality of fingers 331A, with the longitudinal axis of auger 340A being about parallel to a direction E of drive chain 321. Consequently, the longitudinal axis of auger 340A may also be about parallel to the direction of conveyance I of the produce.

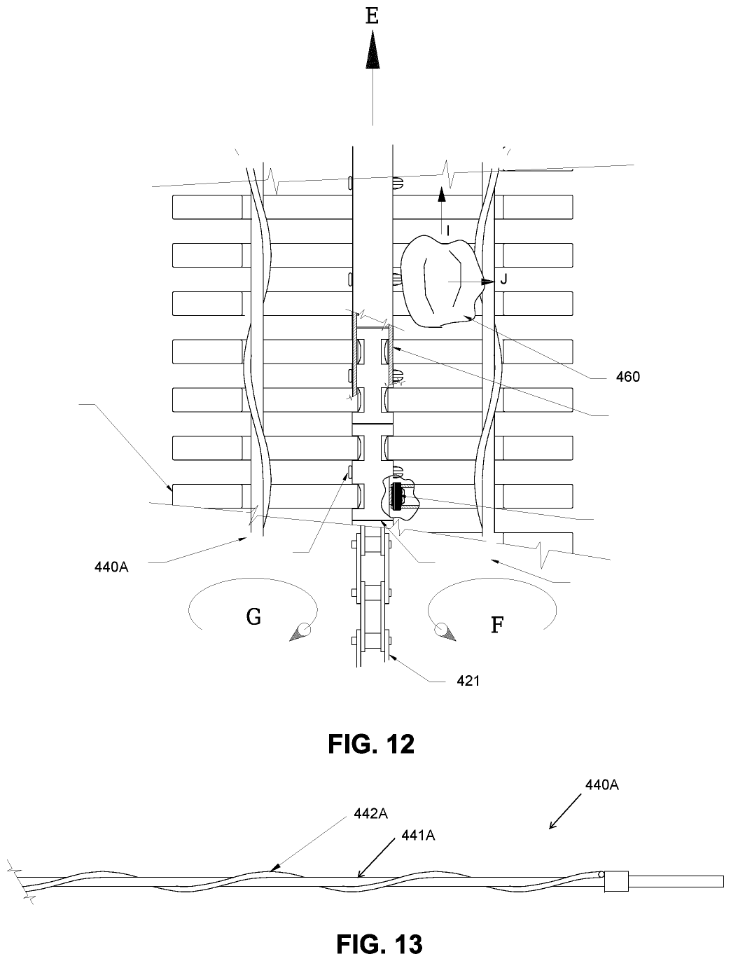

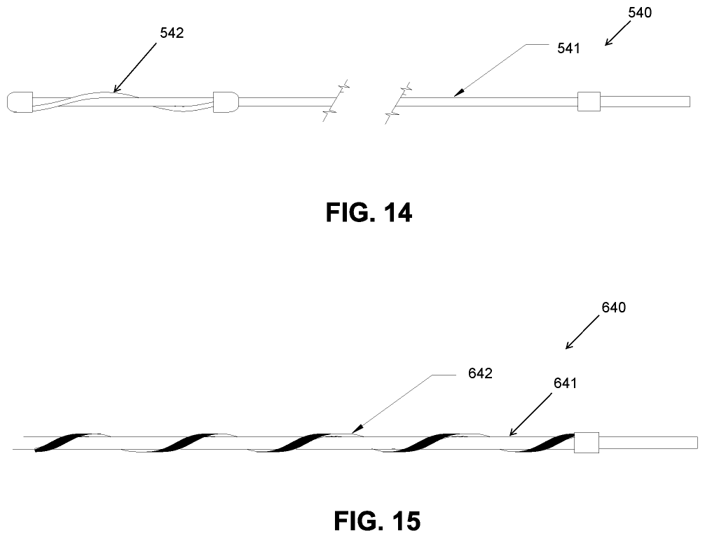

According to some embodiments, an auger may generally comprise a shank and fighting, the flighting of which may be wound around a portion of a length the shank or which may be integrally formed therewith, or otherwise engaged with the shank. For example, referring briefly to FIGS. 12 and 13, an auger 440A may comprise a shank 441A and fighting 442A, generally formed as a ridge, integrally formed with the surface of shank 441A and extending along a portion thereof in a helical pattern. In another example, and as illustrated in FIG. 15, an auger 640 may comprise a shank 641 and fighting 642, generally formed as a ribbon and wound in a helical pattern around shank 641. It is to be appreciated, however, that in other embodiments, an auger may comprise a shank without flighting (e.g., a shank with a smooth surface) or an auger may comprise fighting without a shank (e.g., flighting wound around a hollow center). For example, referring back briefly to FIGS. 10 and 11, auger 340A may comprise a fighting 342A, generally formed as a ribbon and which may be formed in a helical pattern without a shank disposed along a longitudinal axis thereof. It is also to be appreciated that, according to some embodiments, an auger may comprise a shank and fighting which may extend along only a portion of a surface of the shank. For example, as illustrated in FIG. 14, an auger 540 may comprise a shank 541 having a smooth surface over a first portion of a length of shank 541 and with fighting 542 extending along a second portion of the length of shank 541. In some embodiments, and as illustrated in the example of FIG. 14, the fighting may have bumps or protrusions at the ends thereof, which among other things, may restrain forward and backward movement of the produce as it rotates within one or more fingers.

According to some embodiments of the present invention, an auger may be configured to rotate such that it may impart rotation on produce which may be in contact with the auger. In preferred embodiments, an auger may rotate about a longitudinal axis which may be oriented about parallel to a drive chain. For example, referring back to FIG. 5, augers 140A and 140B may be configured to rotate about respective longitudinal axes, such that when the surfaces of augers 140A and 140B contact produce 160A and 160B being conveyed on fingers 131A and 131B, respectively, produce 160A and 160B is caused to rotate in a direction that is generally opposite to that of the auger with which it is in contact (such motion is also illustrated by augers 240A and 240B of FIG. 7). In preferred implementations, the augers (i.e., augers which are engaged to a common drive chain) may rotate in opposite directions. For example, as further illustrated in FIG. 5, auger 140A may rotate in a clockwise direction A (as observed from the view illustrated in FIG. 1, from a loading side to an unloading side of the conveying assembly) and auger 140B may rotate in a counterclockwise direction B (similar motion is also illustrated in FIG. 7). According to preferred implementations, a pair of adjacent augers may rotate towards a drive chain, or more particularly, a top surface of each auger may rotate toward the drive chain. For example, as further illustrated in FIG. 5, a top surface of augers 131A and 131B may simultaneously rotate toward drive chain 121, indicated by directions A and B, respectively. At the same time, a top surface of produce 160A and 160B rotate away from drive chain 121, indicated by directions D and C, respectively (see also, e.g., augers 231A and 231B and produce 260A and 260B of FIG. 7). In some implementations, an auger may have a rotational speed which may be about the same as a speed of a drive chain.

Referring now, generally to FIGS. 10 and 12, a conveying motion, auger motion, and produce motion are illustrated during operation of a conveying assembly. For example, the direction of drive chain 321 and 421 is illustrated by direction E, which may be toward an unloading end of the conveying assembly. As drive chain 321 and 421 move in direction E, fingers 331A and 331B and fingers 431A and 431B indirectly engaged to drive chain 321 and 421 by finger mounting brackets, respectively, may be driven in a direction parallel to direction E so as to convey produce 360 and 460, respectively, toward the unloading end, indicated by direction I. According to some aspects, an auger may also assist with the conveyance of produce by forcing the produce in the direction of conveyance and/or reducing drag on the produce caused by frictional forces between the fingers and the produce being conveyed thereon. For example, it is to be noted that for augers which comprise helically formed fighting, the helical nature may induce motion of the produce in the direction of conveyance. Furthermore, an auger may also assist with the retention of produce on one or more corresponding fingers as the produce is conveyed through the conveying assembly.

In accordance with some embodiments of the present invention, during conveyance of produce by a conveying assembly, an auger may simultaneously rotate about its longitudinal axis to induce rotation on the produce. For example, as further illustrated in FIG. 10, as produce 360 is being conveyed by fingers 331B, auger 340B may simultaneously rotate, making contact with an outer lateral surface of produce 360 (i.e., the portion of the surface generally oriented away from drive chain 321), thus causing produce 360 to rotate in an opposite rotational direction to that of auger 340B. In this case, auger 340B may rotate in a counterclockwise direction F (as viewed in FIG. 10) while produce 360 rotates in a clockwise direction, causing a top surface of produce 360 (i.e., the surface generally visible in FIG. 10) to rotate generally toward direction J. It is to be appreciated that, by the concurrent motions of a drive chain (and thus fingers) and an auger, produce may be conveyed in a first direction (e.g., direction I) while simultaneously rotating about an axis which may be about parallel to the direction of conveyance. For example, as produce 360 is conveyed by fingers 331B and rotated by auger 340B, its direction of travel is perpendicular to its rotational direction. In preferred embodiments, at least a portion of each auger extends into the inspection portion of the system (e.g., inspection portion 15 of FIG. 1) enabling orthogonal rotation of the produce as it is under inspection such that at least a substantial portion of the lateral surface of the produce can be exposed to inspection elements (e.g., stationary inspection cameras).

According to some embodiments of the present invention, as a finger travels in the direction of conveyance, its orientation may be retained by a retention track engaged with the finger. For example, referring back to FIG. 5, finger 131A may comprise a retention tab 134A which may be housed in a finger retention track 151 (see also, e.g., retention tab 234A and retention track 251 of FIG. 7). As finger 131A travels, retention tab 134A may abut an inside surface of finger retention track 151, thus preventing finger 131A from pivoting downward.

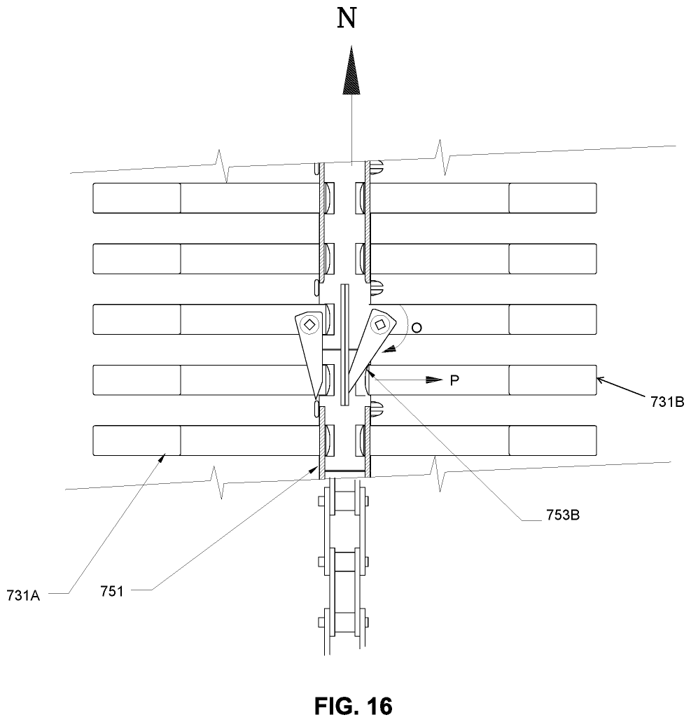

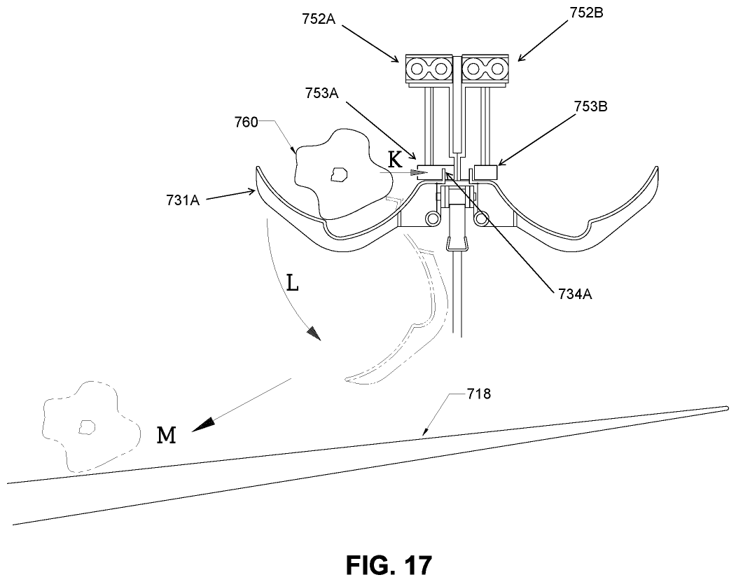

Upon reaching an unloading portion of the conveying assembly, a finger retention track may become discontinuous (whereas, throughout other portions, the finger retention track may be continuous so that a retention tab of a finger is continuously retained to maintain an orientation of a finger). For example, referring now, generally, to FIGS. 16 and 17, and according to some embodiments, a section of an unloading portion of conveying assembly is illustrated whereby a finger retention track 751 comprises openings in sidewalls thereof to allow fingers 731A and 731B to change orientations. In some embodiments, the openings may be complete or near complete openings (i.e., “breaks”) in the finger retention track. According to some embodiments of the present invention, an actuator may control a cam disposed adjacent to an opening of a finger retention track which may allow a retention tab of a finger to be released from the finger retention track and thus allow the finger to eject produce from the conveying line. For example, as further illustrated in FIGS. 16 and 17 an ejection actuator 752B may be operatively engaged with an ejection cam 753B disposed within an opening in finger retention track 751. Before produce may ejected, fingers 731A and 731B may be in a first orientation (i.e., a conveyance position), as illustrated in solid lines in FIG. 17, and ejection cam 753A and 753B may be in a first orientation (i.e., in a non-actuated position). When a finger approaches an opening in a finger retention track, an ejection actuator may actuate an ejection cam to allow the release of a corresponding retention tab of the finger. For example, as illustrated in FIG. 16, as finger 731B approaches the opening in finger retention track 752, ejection actuator 752B may actuate ejection cam 753B such that a free end of ejection cam 753B may pivot in direction O inside of finger retention track 751. By this motion, the retention tab of finger 731B, which is moving in direction N, contacts an outer surface of ejection cam 753B and drives the retention tab in direction P.

In some embodiments, as finger 731A approaches the opening in finger retention track 751, ejection actuator 752A may actuate ejection cam 753A such that a free end of ejection cam 753A may pivot in direction K. By this motion, retention tab 734A of finger 731A contacts an outer surface of ejection cam 753A and drives retention tab 734A away from finger retention track 752, thus causing the free end of finger 731A to pivot downward in direction L. When finger 731A pivots downward, this causes the ejection of produce 760 from finger 731A, in direction M, and onto an unloading chute 718 (with the positions of finger 731A and produce 760 after ejection shown in broken lines).

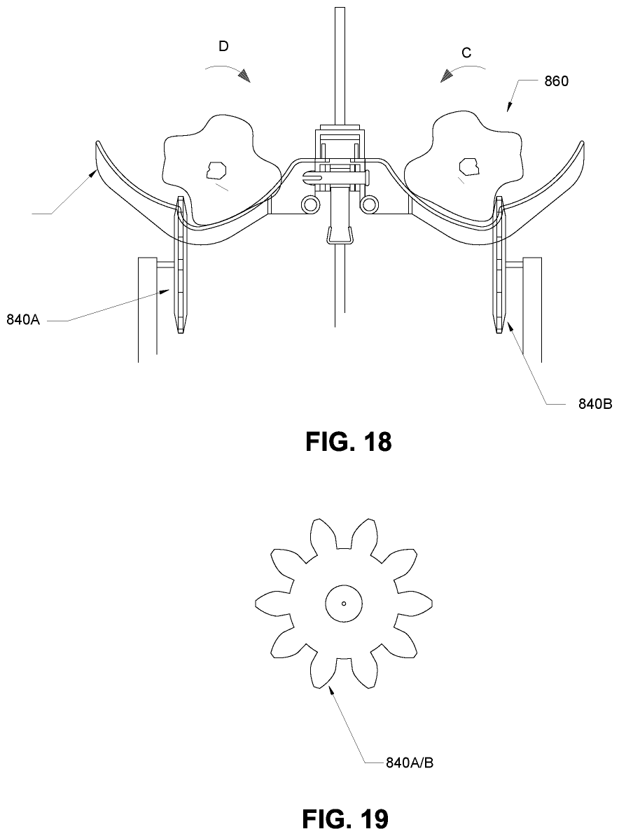

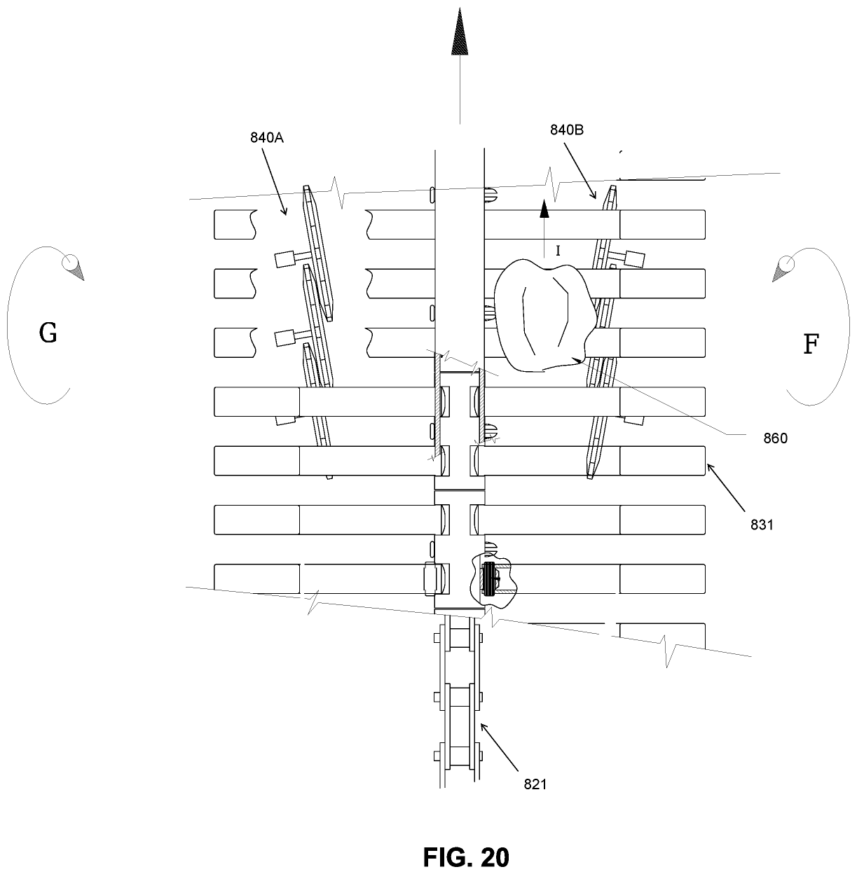

Referring now to FIGS. 18-20, and according to some embodiments of the present invention, a conveying assembly may comprise a plurality of gears disposed underneath a plurality of fingers. For example, a plurality of gears 840A and 840B may be generally aligned with an apex of fingers and which my generally rotate (indicated by directions G and F, respectively) in a direction of conveyance (indicated by the arrow at the top of FIG. 20). In some embodiments, the gears may have an axis of rotation that is perpendicular to the chain. In preferred embodiments, a tooth pitch and width of a gear may correspond to a space between adjacent fingers (see, e.g., FIG. 20). As also further illustrated in FIG. 10, and according to some embodiments, gears 840A and 840B may be arranged generally in a line with portions of adjacent gears overlapping each other. Furthermore, gears 840A and 840B may be slightly tilted away from a centerline which may be about parallel to the direction of conveyance causing the rotational axis of the gears, in some embodiments, to be slightly offset or rotated. More particularly, a back end of each of gears 840A and 840B (i.e., the end toward the bottom of FIG. 20) may be pointed slightly toward drive chain 821 and a front end of each of gears 840A and 840B (i.e., the end toward the top of FIG. 20) may be pointed slightly away from drive chain 821. During operation, as fingers 831 move in the direction of conveyance, they may catch the teeth of gears 840A and 840B, thus driving rotation of the gears. As gears 840A and 840B rotate, the tips of gear teeth of gears 840A and 840B may make contact with a lateral surface of produce 860, causing rotation thereof. According to some embodiments, gears 840A and 840B may be configured to contact fingers 831, causing the free end of fingers 831 to be bumped in an upward direction (according to the orientation of FIG. 18) which may assist with the rotation of produce 860.

It is to be understood that variations, modifications, and permutations of embodiments of the present invention may be made without departing from the scope thereof. It is also to be understood that the present invention is not limited by the specific embodiments, descriptions, or illustrations or combinations of either components or steps disclosed herein. Thus, although reference has been made to the accompanying figures, it is to be appreciated that these figures are exemplary and are not meant to limit the scope of the invention.

What is claimed is:

1. A system for the conveyance of produce comprising:
a) a drive chain;
b) a finger retention track above said drive chain;
c) a finger mounting bracket engaged with said drive chain;
d) a finger comprising a surface for supporting said produce and a retention tab, wherein said finger is hingedly engaged with said finger mounting bracket, and
wherein said finger surface
(i) distally extends from said finger mounting bracket,
(ii) comprises a generally upwardly convex shape, and
(iii) comprises a cavity near the apex thereof; and
e) an elongate auger for rotating said produce and having a longitudinal axis that is parallel to said drive chain, wherein said auger
(i) is at least partially positioned in said cavity of said finger surface,
(ii) comprises a top surface rotatable towards said drive chain, and
(iii) comprises a shaft and fighting.

2. The system of claim 1, further comprising a chain support below said drive chain.

3. The system of claim 2, wherein said drive chain slidably engages said chain support.

4. The system of claim 1, wherein said finger has a first orientation and a second orientation.

5. The system of claim 4, wherein when said finger has said first orientation, said retention tab of said finger is within said finger retention track.

6. The system of claim 5, wherein when said finger has said second orientation, said retention tab of said finger is not within said finger retention track.

7. The system of claim 1, wherein said auger flighting is around a portion of said auger shaft.

8. The system of claim 1, wherein said auger fighting is integrally formed with said auger shaft.

9. The system of claim 1, wherein said auger flighting is engaged with said auger shaft.

10. The system of claim 1, wherein said auger fighting has a helical shape.

11. The system of claim 1, further comprising an auger drive for rotating said auger, said auger drive comprising a shaft.

12. The system of claim 11, wherein said auger drive comprises a pulley engaged with said auger shaft, a pulley engaged with said auger drive shaft, and a belt engaged to each of said pulley of said auger shaft and said pulley of said auger drive shaft.

13. The system of claim 11, further comprising a motor engaged to said auger drive shaft.

14. A system for inspecting produce having a loading portion, an inspection portion, and an unloading portion and comprising a plurality of lanes, each lane comprising:
a) a drive chain between a drive chain support and a finger retention track;
b) a plurality of fingers on each side of said drive chain, wherein each of said fingers is hingedly engaged with a corresponding one of a plurality of finger mounting brackets, wherein each of said finger mounting brackets is engaged with said drive chain, and wherein each of said fingers
(i) comprises a surface for supporting said produce and having a cavity therein,
(ii) comprises a retention tab, and
(iii) has a first orientation and a second orientation; and
c) at least two augers, wherein a first auger is on a first side of said drive chain and wherein a second auger is on a second side of said drive chain, wherein each of said augers
(i) has a longitudinal axis that is parallel to said drive chain,
(ii) is at least partially positioned in said cavities of said surfaces of at least two of said fingers, and
(iii) comprises a top surface which rotates toward said drive chain.

15. The system of claim 14, wherein in said loading portion, each of said fingers have said first orientation and said retention tab of each of said fingers is within said finger retention track.

16. The system of claim 14, wherein in said inspection portion, each of said fingers have said first orientation and said retention tab of each of said fingers is within said finger retention track.

17. The system of claim 14, wherein in said inspection portion, said auger comprises fighting for rotating said produce for inspection.

18. The system of claim 14, wherein in said unloading portion, each finger retention track comprises a plurality of openings therein.

19. The system of claim 18, wherein in said unloading portion, said retention tab of each of said fingers is ejected from one of said finger retention track openings.

20. The system of claim 19, wherein each lane further comprises a plurality of ejection actuators having an ejection cam engaged thereto, and wherein said ejection cam has a first orientation and a second orientation.

21. The system of claim 20, wherein each of said ejection cams are positioned near one of said finger retention track openings.

22. The system of claim 21, wherein when said ejection cam has said first orientation, said cam is outside of said finger retention track opening, and wherein when said ejection cam has said second orientation, a portion of said ejection cam is through said finger retention track opening and in said finger retention track.

23. The system of claim 14, wherein:
a) in said loading portion
(i) each of said fingers has said first orientation and
(ii) said retention tab of each of said fingers is within said finger retention track;
b) in said inspection portion
(i) each of said fingers has said first orientation,
(ii) said retention tab of each of said fingers is within said finger retention track, and
(iii) said auger comprises flighting for rotating said produce for inspection; and
c) in said unloading portion
(i) each finger retention track comprises a plurality of openings therein,
(ii) each lane further comprises a plurality of ejection actuators having an ejection cam engaged thereto, wherein each of said ejection cams are positioned near one of said finger retention track openings,
(iii) said ejection cam has a first orientation when said ejection cam is outside of said finger retention track opening, and
(iv) said ejection cam has a second orientation when a portion of said ejection cam is through said finger retention track opening and in said finger retention track.

24. A method for conveying produce through a machine comprising a drive chain and having a loading, inspection, and unloading portion, said drive chain moving from said loading portion to said inspection portion and from said inspection portion to said unloading portion, said method comprising the steps of:
a) in said loading portion,
(i) positioning a retention tab of each of a plurality of fingers within a finger retention track, each of said plurality of fingers hingedly engaged with one of a plurality of finger mounting brackets, each finger mounting bracket engaged with said drive chain, and
(ii) placing said produce on a surface of at least one of said plurality of fingers;
b) in said inspection portion,
(i) positioning said produce to be engaged with an auger, wherein said auger is at least partially positioned in a cavity of said finger surface and has a longitudinal axis that is parallel to said drive chain, and
(ii) rotating said auger to cause said produce to rotate along an axis which is parallel with said longitudinal axis of said auger; and
c) in said unloading portion,
(i) ejecting each said retention tab through one of a plurality of openings in said finger retention track, and
(ii) removing said produce from said surface of said finger.
